(19) United States
(12) Patent Application Publication
(10) Pub. No.: US 2010/0276571 A1
(43) Pub. Date: Nov. 4, 2010

(54) CALIBRATION METHOD FOR SOLAR SIMULATORS USIED IN SINGLE JUNCTION AND TANDEM JUNCTION SOLAR CELL TESTING APPARATUS

(75) Inventors: Dapeng Wang, Santa Clara, CA (US); Michel Frei, Palo Alto, CA (US); Tzay-Fa Su, San Jose, CA (US); David Tanner, San Jose, CA (US)

Correspondence Address: DIEHL SERVILLA LLC, 33 WOOD AVE SOUTH, SECOND FLOOR, SUITE 210, ISELIN, NJ, 08830, US

(73) Assignee: Applied Materials, Inc., Santa Clara, CA (US)

(21) Appl. No.: 12/772,430

(22) Filed: May 3, 2010

Related U.S. Application Data
(60) Provisional application No. 61/175,109, filed on May 4, 2009.

(51) Int. Cl. G01J 1/32

(52) U.S. Cl. 250/205

(57) ABSTRACT

A method of calibrating a light source used to simulate the sun in solar cell testing apparatus. The method comprises using a control cell to measure the intensity of light from the light source at a first wavelength range as a function of output short circuit current, comparing the measured intensity to a targeted intensity value, optionally adjusting power to the light source until the measured intensity is substantially equal to the targeted intensity value, repeatedly using a calibrated monitoring module to periodically measure monitoring measured values for monitoring module output short circuit current, monitoring module output open circuit voltage and monitoring module quantum efficiency, obtaining average values for monitoring module output short circuit current, monitoring module output open circuit voltage and monitoring module quantum efficiency, comparing the measured values with the average values, and determining if differences in measured values and average values are within an acceptable limit.

### CROSS-REFERENCE TO RELATED APPLICATIONS

This application claim priority under 35 U.S.C. §119(e) to U.S. Provisional Patent Application No. 61/175,109, filed May 4, 2009, the disclosure of which is hereby incorporated herein in its entirety.

### BACKGROUND OF THE INVENTION

Embodiments of the present invention generally relate to devices used to test solar cells, and particularly to a procedure for calibrating a light source used to simulate the sun in a solar cell testing apparatus.

### DESCRIPTION OF THE RELATED ART

Photovoltaic devices, such as solar cells, convert light into direct current electrical power. Thin film silicon solar cells typically are formed on a substrate and have one or more p-i-n junctions. Each p-i-n junction comprises a p-type layer, an intrinsic type layer, and an n-type layer that are amorphous, polycrystalline or microcrystalline materials. When the p-i-n junction of a solar cell is exposed to sunlight, consisting of energy from photons, the sunlight is converted to electricity. Solar cells may be tiled into larger modules or arrays.

Typically, a thin film photovoltaic solar cell includes active regions and a transparent conductive oxide film disposed as a front electrode and/or as a back electrode. The photoelectric conversion unit includes a p-type silicon layer, an n-type silicon layer, and an intrinsic type (i-type) silicon layer sandwiched between the p-type and n-type silicon layers. Several types of silicon films including microcrystalline silicon film (μc-Si), amorphous silicon film (a-Si), polycrystallinesilicon film (poly-Si) and the like may be utilized to form the p-type, n-type, and/or i-type layers of the solar cell. The backside contact may contain one or more conductive layers.

To assure that solar cell devices formed in a solar cell production line meet desired power generation and efficiency standards, various tests are performed on each formed solar cell. In some cases, a dedicated solar cell qualification module is placed in the solar cell production line to qualify and test the output of the formed solar cells. Typically, in these qualification modules a light emitting source and a solar cell probing device are used to measure the output of the formed solar cell. If the qualification module detects a defect in the formed device, it can take corrective actions or the solar cell can be scrapped. However, to assure that the tests performed in the testing module are the same for every tested device, the qualification module must be calibrated and recalibrated from time to time. The calibration and recalibration process requires the use of a number of devices, which may include a reference solar cell used to qualify the output of lamps and the environment of the testing module.

Multiple junction tandem solar cells comprise a plurality of (typically three) distinct layers of photovoltaic devices that are electrically connected in series to one another. Each layer uses a different portion of the solar spectrum, thereby taking advantage of the fact that devices sensitive to short wavelength light can be transparent to longer wavelengths.

When solar cells are manufactured, especially for space-based applications, testing of each cell is important in order to ensure adequate performance. Multiple junction solar cells are typically tested under a steady state solar simulator using relatively slow curve tracing and data acquisition equipment. The steady state solar simulator is a large, expensive device and at best has temporal instability (“flicker”) in the range of a few percent. Adjusting the spectral filtering for multiple junction solar cells requires additional equipment.

For space-based applications, it is desirable to simulate sunlight that impinges an orbiting satellite, which is commonly known as Air Mass Zero sunlight, or AM0. Although the light source used for simulation of AM0 sunlight for electrical tests of solar cells need not be an exact match at all wavelengths (which would be extremely difficult), it must produce the same effect on each individual junction as would AM0 sunlight.

The photoelectric conversion characteristics of photovoltaic devices, photo sensors and the like are measured by measuring the current-voltage characteristics of the photovoltaic devices under irradiance. In the measurement of the characteristics of photovoltaic devices, a graph is set up with voltage on the horizontal axis and current on the vertical axis and the acquired data is plotted to obtain a current-voltage characteristics curve. This curve is generally called an I-V curve.

As the measurement methods, there are methods that use sunlight as the irradiating light and methods that use an artificial light source as the irradiating light. Of the methods that use an artificial light source, methods that use a fixed light and methods that use a flash are described in, for example, Japanese Patent No. 2886215and Laid-open Japanese Patent Application No. 2003-31825.

Conventionally, with the commercialization of photovoltaic devices, and particularly with photovoltaic devices with large surface areas, the current-voltage characteristics are measured under a radiation irradiance of 1,000 W/m², which is sunlight standard irradiance. Measured values are corrected mathematically by formula so as to compensate for when irradiation during measurement exceeds or falls short of 1,000 W/m².

In addition, measurement of the current-voltage characteristics of large-surface-area photovoltaic devices requires irradiation of light with an irradiance of 1,000 W/m² to a large-surface-area test plane uniformly. As a result, when using an artificial light source, for example, a high-power discharge lamp capable of providing several tens of kilowatts per square meter of radiation surface is required. However, in order for such a high-power discharge lamp to provide a fixed light it must be provided with a steady supply of high power. As a result, very large-scale equipment is required, which is impractical.

Furthermore, with a solar simulator that uses a steady light, a xenon lamp, a metal halide lamp or the like for continuous lighting is used as the light source lamp. It usually takes several tens of minutes or more from the start of lighting of such lamps until irradiance stabilizes. Moreover, unless lighting is continued under the same conditions, the irradiance does not reach saturation and a great deal of time is required until measurement is started. On the other hand, as the accumulated lighting time grows by long hours of lighting, the irradiance tends to decrease gradually and thus the irradiance characteristics are not stable. In addition, the radiation of the light on the photovoltaic devices under measurement is conducted by changing shielding and irradiation of light with the opening and the closing of the shutter. Thus, the irradiation time required for the devices under testing depends on the operating speed of the shutter, and often exceeds several hundred milliseconds. As the irradiation time lengthens, the temperatures of the photovoltaic devices rise, thus making accurate measurement difficult.

With a solar simulator that uses a fixed light, although it is necessary to maintain continuous lighting in order to stabilize the irradiance, doing so causes the temperature inside the housing that contains the light source to increase sharply. In addition, the components inside the housing are constantly exposed to light, which causes the optical components (minors, optical filters, etc.) to deteriorate.

Once a fixed light source lamp is turned off and turned on again, it takes several tens of minutes for the irradiance to reach saturation. In order to avoid this, the fixed light source lamp is usually kept on and used as is. As a result, however, the accumulated lighting time of such fixed light lamps adds up easily and results in a tendency for the lamps to reach the end of their useful lives relatively quickly. Therefore, when using a fixed light-type solar simulator in a photovoltaic devices module production line, the number of lamps that burn out is added to the running cost, which increases not only the cost of measurement but also the cost of production.

Moreover, with a fixed light solar simulator, the length of time during which light from the light source irradiates the photovoltaic devices under measurement is relatively long. As a result, when I-V curve measurements are repeated for the same photovoltaic devices, the temperatures of the photovoltaic devices increase. As the temperature of the photovoltaic devices increases, the output voltage and the maximum output power, Pₘₐₓ, tend to decrease.

In general, measurement of the photovoltaic devices current-voltage characteristics requires indicating standard test condition values. Here, the temperature of the photovoltaic devices under standard test conditions is 25° C. and the radiation irradiance is 1,000 W/m². The measurement of the current-voltage characteristics of photovoltaic devices by a solar simulator is carried out with the temperature range of the photovoltaic devices in the range of 15° C.-35° C. The temperature is corrected to 25° C., the reference temperature, using a measured temperature of the photovoltaic devices. The correction formula used for this purpose is prescribed by industry standard.

Thus, in order to ensure accurate output current and voltage performance measurements, there is a need for a viable and repeatable method of calibrating the light source used in testing photovoltaic devices.

### SUMMARY OF THE INVENTION

A method of calibrating a light source used as a solar simulator in solar cell testing apparatus comprising:

a) using a control cell to measure the intensity of light from the light source at a first wavelength range, the intensity being measured as a function of output short circuit current of the control cell; b) comparing the measured intensity to a targeted intensity value; c) optionally adjusting power to the light source until the measured intensity is substantially equal to the targeted intensity value; d) using a calibrated monitoring module to periodically measure monitoring measured values for monitoring module output short circuit current, monitoring module output open circuit voltage and monitoring module quantum efficiency; e) repeating step d) and obtaining average values for monitoring module output short circuit current, monitoring module output open circuit voltage and monitoring module quantum efficiency; f) comparing the measured values obtained in step d) with the average values obtained in step e); and g) determining if differences in the measured values obtained in step d) and the average values obtained in step e) are within an acceptable limit

In one embodiment, the method further includes, in step a), using a control cell to measure the intensity of light from the light source at a second wavelength range, the intensity being measured as a function of output short circuit current of the control cell and calculating a ratio of light intensity at the first and second wavelengths to provide a measured intensity ratio, and in step b) comparing the measured intensity ratio to a targeted intensity ratio value.

In one embodiment, when the differences obtained in step g) are greater than an acceptable value, the method further comprises: h) using a calibrated reference module to obtain reference module measured values for reference module output short circuit current, reference module output open circuit voltage and reference module quantum efficiency; i) comparing the reference module measured values obtained in step h) to calibrated values for output short circuit current, open circuit voltage and quantum efficiency; and j) determining if differences in measured values obtained in step h) and calibrated values are within an acceptable limit

In one embodiment, when the differences obtained in step j) are greater than an acceptable value, the method further comprises: k) adjusting power to the light source until the measured output short circuit current is within the acceptable limit In this embodiment, the method may further comprise: l) repeating step h); m) comparing the reference module measured values obtained in step l) to calibrated values for output short circuit current, open circuit voltage and quantum efficiency; and n) determining if differences in measured values obtained in step l) and calibrated values are within an acceptable limit. In a specific embodiment, when the differences obtained in step n) are less than an acceptable value, the method further comprises: o) using the calibrated reference module to obtain a reference module measured value for reference module output short circuit current; and p) determining if a difference in measured value obtained in step o) and a calibrated value is within an acceptable limit

According to one embodiment, steps a) through c) are performed for each solar cell measurement, steps d) through g) are performed at least once daily, and steps g) through h) are performed on a weekly basis.

In a specific embodiment, an acceptable percentage difference between the measured intensity and the targeted intensity value in b) is about 1%.

In another specific embodiment, an acceptable percentage difference in monitoring module output short circuit current determined in step g) is about 2%, an acceptable percentage difference in monitoring module output open circuit voltage determined in step g) is about 2% and an acceptable percentage difference in monitoring module quantum efficiency determined in step g) is about 4%.

In another specific embodiment, an acceptable percentage difference in monitoring module output short circuit current determined in step j) is about 1%, an acceptable percentage difference in monitoring module output open circuit voltage determined in step j) is about 1% and an acceptable percentage difference in monitoring module quantum efficiency determined in step j) is about 2%.

In one embodiment, the targeted maximum percentage voltage difference in n) is about 1% and the targeted maximum percentage efficiency difference in n) is about 2%. In at least one embodiment, the control cell is a single crystal silicon cell having an appropriate band pass filter approximating tandem-junction spectra responses, has dimensions of about 2 cm×2 cm and is mounted in a hermetic package. In one embodiment, the monitoring module comprises a junction box which is also used to monitor intensity of light from the light source and electrical connections.

According to one or more embodiments, the reference module is a filtered crystal silicon module designed to match an output short circuit current, an output open circuit voltage and a quantum efficiency of an amorphous silicon module.

In one or more embodiments, the reference module is a crystal silicon solar cell module with dimensions of about 50 cm×50 cm and having a plurality of cells in series and an appropriate band pass filter.

In certain embodiments, the solar cell testing apparatus is configured for measuring tandem junction solar cell modules.

In one or more embodiments, the method comprises, in step a), monitoring an intensity of light from the light source by measuring an output short circuit current of the control cell on a daily basis.

In a specific embodiment, the method includes, in step d), measuring an output short circuit current, an output open circuit voltage and a quantum efficiency of the monitoring module on a daily basis.

In a specific embodiment, the method includes, in step h), measuring an output short circuit current, an output open circuit voltage and a quantum efficiency of the reference module on a weekly basis.

In specific embodiments, the first wavelength range is in the range of about 620 nm to 750 nm, and the second wavelength range is in the range of about 440 nm to 490 nm.

In specific embodiments, an acceptable percentage difference between the measured intensity and the targeted intensity value in b) is about 1% or about 3%. In other specific embodiments, an acceptable percentage difference in monitoring module output short circuit current determined in step g) is about 2%, an acceptable percentage difference in monitoring module output open circuit voltage determined in step g) is about 2% and an acceptable percentage difference in monitoring module quantum efficiency determined in step g) is about 4%.

In other specific embodiments, an acceptable percentage difference in reference module output short circuit current determined in step j) is about 1%, an acceptable percentage difference in reference module output open circuit voltage determined in step j) is about 1% and an acceptable percentage difference in reference module quantum efficiency determined in step j) is about 2%.

The foregoing has outlined rather broadly certain features and technical advantages of the present invention. It should be appreciated by those skilled in the art that the specific embodiments disclosed may be readily utilized as a basis for modifying or designing other structures or processes within the scope present invention. It should also be realized by those skilled in the art that such equivalent constructions do not depart from the spirit and scope of the invention as set forth in the appended claims.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawing. It is to be noted, however, that the appended drawing illustrates only typical embodiments of this invention and is therefore not to be considered limiting of its scope, for the invention may admit to other equally effective embodiments.

FIG. 1 is an enlarged isometric view of one embodiment of a solar cell testing apparatus used in the calibration method of the present invention.

FIG. 2 is an enlarged isometric view of one embodiment of a control cell used in the calibration method of the present invention.

FIG. 3 is an elevated isometric view of one embodiment of a monitoring module or a reference module used in the calibration method of the present invention.

FIG. 4 is a cross-sectional side view of one embodiment of a monitoring module or a reference module used in the calibration method of the present invention.

### DETAILED DESCRIPTION OF THE INVENTION

Embodiments of the present invention provide a solar cell testing apparatus and methods of calibrating a light source used to simulate the sun in the solar cell testing apparatus.

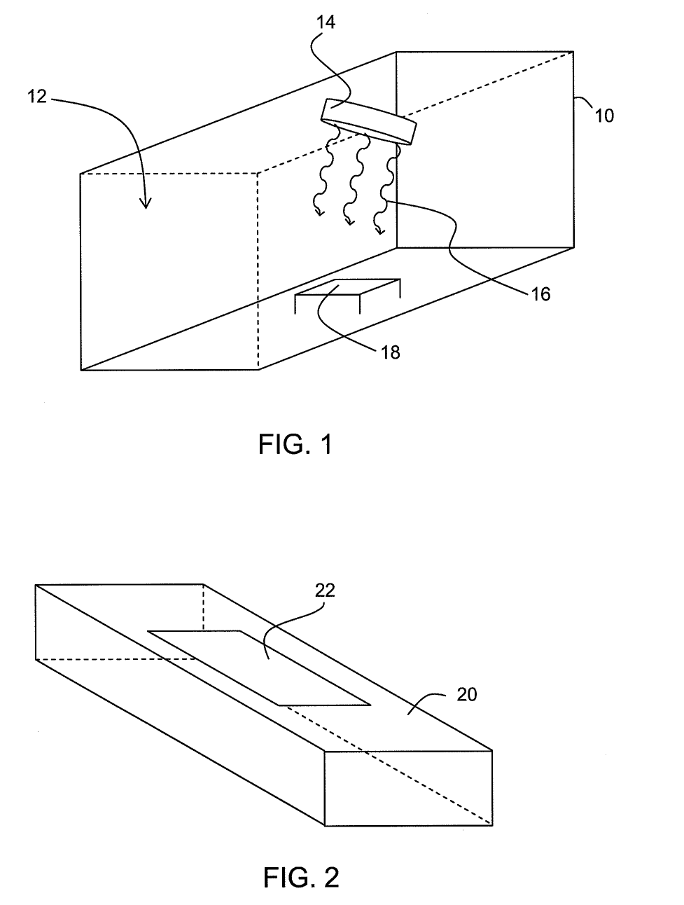

Equipment utilized in the inventive solar simulator calibration procedure will be discussed first. FIG. 1 depicts an exemplary embodiment of a solar cell testing apparatus 10, which can be of any appropriate size and configuration for testing a variety of differently sized modules. In the interior 12 of the apparatus 10, a light source 14 such as a lamp is present. The light source 14 serves as a solar simulator; it has the capacity of providing light 16 as intense as sunlight. The light source 14 may be physically attached to a wall of the apparatus 10, as shown, or freestanding in the interior 12 of the apparatus 10. Power can be supplied to the light source 14 through a variety of means as well known in the art. A substrate holder 18 is positioned inside the apparatus 10 so that the light 16 focuses directly on its upper surface. The holder 18 is appropriately sized to accommodate at least one module of solar cells.

A control cell 20 for use in the present invention is shown in FIG. 2. The control cell 20 may consist of monocrystalline silicon and have a rectangular shape. For example, the control cell 20 may be an Oriel or a Sinton cell having dimensions of 2 cm×2 cm and may be mounted in a hermetic package. A filter 22 is securely adhered to the upper surface of the control cell 20. According to one embodiment, the filter 22 is an Oriel KG5 filter, which is a colored glass filter capable of serving as a broadband, band-pass or long-wave pass filter. In certain embodiments, the filter 22 is an appropriate band pass filter approximating tandem-junction spectra responses. The filter 22 is glued or otherwise fastened to the control cell 20.

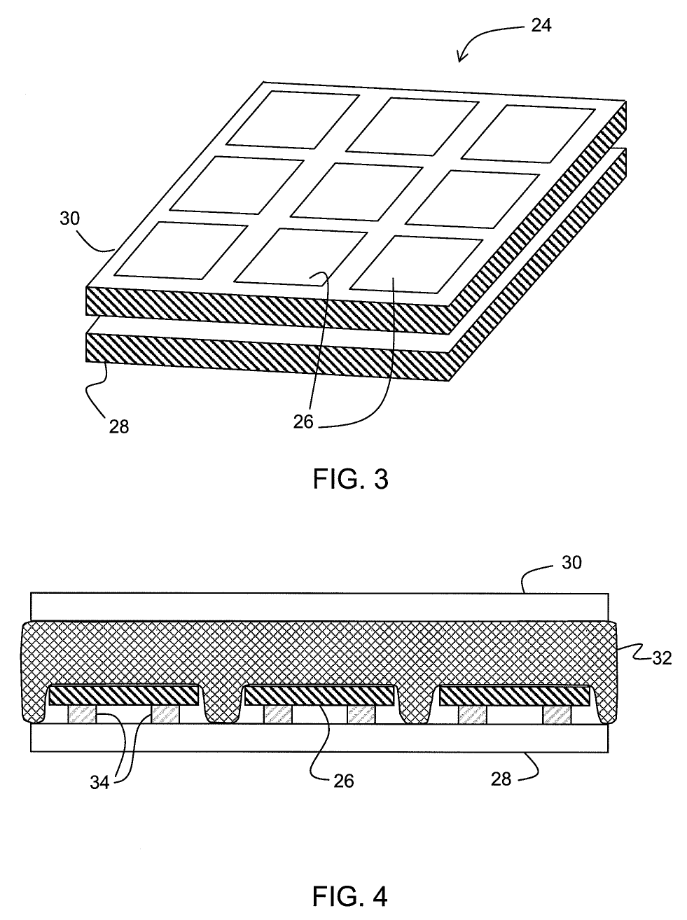

FIG. 3 illustrates one embodiment of a monitoring module or a reference module 24 utilized to test the light source 14 used to qualify one or more solar cells formed in a solar cell production line. Generally, the monitoring module or reference module 24 contains an array of cells 26 positioned on a substrate 28 so that when the module 24 is positioned and oriented in a desired location, at least a portion of the light 16 from the light source 14 can be received by each cell 26. The module 24 may have dimensions of, for example, 50 cm×50 cm. The substrate 28 can be formed from any desirable material capable of supporting and retaining the cells 26. In one embodiment, the substrate 28 is made from a material such as a glass or a metal. According to other embodiments, the substrate 28 is either made from or at least partially covered with a dielectric material that will provide electrical isolation between the metal connections formed on each of the cells 26, and between two or more cells 26. The cells 26 in the module 24 may also be encapsulated between the substrate 28 and a cover 30 to prevent environmental attack of the cells 26 or other components in the module 24, which may degrade the long-term performance of the module 24. The module 24 may comprise a junction box which is also used to monitor intensity of the light 16 from the light source 14 and electrical connections. In certain embodiments, the module 24 is designed to match an output short circuit current, an output open circuit voltage and a quantum efficiency of an amorphous silicon module.

A schematic cross-sectional side view of the module 24 is presented in FIG. 4. A layer of a polymeric material 32 has been disposed between the cover 30 and the cells 26 and substrate 28 to isolate the cells 26 and other components from the environment. In one embodiment, the polymeric material 32 is a polyvinyl butyral or ethylene vinyl acetate, which is sandwiched between the substrate 28 and the cover 30 using a process that provides heat and pressure to form a bonded and sealed structure. In general, the cover 30 and polymeric material 32 are made from a material that is optically transparent to allow the light 16 delivered from the light source 14 to reach the cells 26. In one embodiment, the cover 30 is made of a glass, sapphire or quartz material. While not shown in FIGS. 3 and 4, the module 24 also generally contains a support frame that is used to retain, support and mount one or more components in the reference module.

In one embodiment, as shown in FIG. 4, each cell 26 is attached to the substrate 28 using one or more supports 34. In one embodiment, the supports 34 are electrically conductive and are formed and positioned in a desired pattern on the substrate 28 to electrically connect the cells 26 so that a desired power output can be achieved when a desired amount of light is delivered to the module 24. In one aspect of the invention, all of the cells 26 are connected in series so that desired electrical output can be achieved. In cases where the cells have connections on both sides of each cell 26, the supports 34 and/or other electrical connective elements (not shown) may be used to form a connection path to deliver a desired power output.

According to one embodiment, an optical filter 36 is positioned within the module 24 to block certain wavelengths of light from reaching the cells 26. This configuration allows more stable solar cells with different absorption spectrums to be used in the formed module 24, rather than using a module 24 with solar cells that have similar absorption spectrums but varying electrical properties over time (e.g., silicon thin film solar cells). The more stable solar cells thus allow the module 24 to be a relatively unvarying “gold” calibration standard, which can be used in a solar cell qualification module to assure that it is functioning correctly without worrying about the module's shelf life or number of hours of light exposure. It should be noted that the addition of any filtering type device over the cells 26 will reduce the amount of energy striking the surface of the cells 26. This effect can be compensated for by increasing the total surface area of the cells 26, by using cells 26 that are more efficient than the solar cell devices formed in the production line, and/or by correcting the systematic error by software in the solar cell qualification module. While the filter 36 shown in FIG. 4 is positioned within the module 24, this configuration is not intended to be limiting as to the scope of the invention since the filter 36 could also be affixed to the cover 30, deposited on the cover 30, or the cover 30 could be altered by adding a doped impurity within the cover material to provide a desirable optical filtration.

An exemplary embodiment of the single-junction solar cell light source calibration procedure will now be described. First, the light source 14 is placed inside the apparatus 10 as shown in FIG. 1. The control cell 20 is then placed in the substrate holder 18 and power is supplied to the light source 14. The intensity of light 16 from the light source 14 is monitored by measuring an output short circuit current of the control cell 20. This may be done on a daily basis. Next, a percentage difference between the output short circuit current and an externally calibrated short circuit current of the control cell 20 is calculated. If this percentage difference is greater than a targeted maximum percentage current difference, the power supplied to the light source 14 is adjusted and the resulting output short circuit current of the control cell 20 is measured until the percentage difference is less than the targeted maximum percentage current difference. The targeted maximum percentage current difference may be about 1%.

A monitoring module 24 is then placed inside the apparatus 10 and connected to measurement circuitry. Subsequently, an output short circuit current, an output open circuit voltage and a quantum efficiency of the monitoring module 24 are measured several times. This may be done on a daily basis. A percentage difference between the output short circuit current measured on the last occasion and an average of the previously measured output short circuit currents is then computed. Next, a percentage difference between the output open circuit voltage measured on the last occasion and an average of the previously measured output open circuit voltages is calculated. Likewise, a percentage difference between the quantum efficiency measured on the last occasion and an average of the previously measured quantum efficiencies is also computed. If the percentage difference in short circuit currents is less than a targeted maximum percentage current difference, the percentage difference in open circuit voltages is less than a targeted maximum percentage voltage difference, and the percentage difference in quantum efficiencies is less than a targeted maximum percentage efficiency difference, the method ends and the light source 14 has been calibrated. However, if the percentage difference in short circuit currents is more than the targeted maximum percentage current difference, the percentage difference in open circuit voltages is more than the targeted maximum percentage voltage difference, or the percentage difference in quantum efficiencies is more than the targeted maximum percentage efficiency difference, the procedure continues with a reference module 24, as now discussed. The targeted maximum percentage current difference may be about 2%, the targeted maximum percentage voltage difference may be about 2%, and the targeted maximum percentage efficiency difference may be about 4%.

A reference module 24 is placed inside the apparatus 10 and connected to measurement circuitry. An output short circuit current, an output open circuit voltage and a quantum efficiency of the reference module 24 are then measured. This may be done on a weekly basis. Next, a percentage difference between the measured output short circuit current and an externally calibrated short circuit current is calculated. A percentage difference between the measured output open circuit voltage and an externally calibrated open circuit voltage of the reference module is also computed. Likewise, a percentage difference between the measured quantum efficiency and an externally calibrated quantum efficiency of the reference module is calculated. If the percentage difference in short circuit currents is less than a targeted maximum percentage current difference, the percentage difference in open circuit voltages is less than a targeted maximum percentage voltage difference, and the percentage difference in quantum efficiencies is less than a targeted maximum percentage efficiency difference, the procedure ends and the light source 14 has been calibrated. However, if the percentage difference in short circuit currents is more than the targeted maximum percentage current difference, the power supplied to the light source 14 is adjusted. The resulting output short circuit current of the reference module 24 is measured until the percentage difference in short circuit currents is less than the targeted maximum percentage current difference. The targeted maximum percentage current difference may be about 1%, the targeted maximum percentage voltage difference may be about 1%, and the targeted maximum percentage efficiency difference may be about 2%.

Next, the output short circuit current, the output open circuit voltage and the quantum efficiency of the reference module 24 are measured. Percentage differences between the measured output short circuit current and an externally calibrated short circuit current of the reference module, the measured output open circuit voltage and an externally calibrated open circuit voltage of the reference module, and the measured quantum efficiency and an externally calibrated quantum efficiency of the reference module are then calculated. If the percentage difference in open circuit voltages is more than a targeted maximum percentage voltage difference and the percentage difference in quantum efficiencies is more than a targeted maximum percentage efficiency difference, a detailed system check of the apparatus 10 must be undertaken. If the percentage difference in short circuit currents is less than a targeted maximum percentage current difference, the method terminates. Alternatively, if the percentage difference in short circuit currents is more than the targeted maximum percentage current difference, a detailed system check of the apparatus 10 must be performed. The targeted maximum percentage voltage difference may be about 1%, and the targeted maximum percentage efficiency difference may be about 2%.

An exemplary embodiment of the tandem-junction solar cell light source calibration procedure will now be described. First, the light source 14 is placed inside the apparatus 10 as shown in FIG. 1. A first control cell is then placed in the substrate holder 18 and power is supplied to the light source 14. The intensity of light 16 from the light source 14 is monitored by measuring an output short circuit current of the first control cell. Next, a percentage difference between the output short circuit current and an externally calibrated short circuit current of the first control cell is calculated. If this percentage difference is greater than a targeted maximum percentage current difference, the power supplied to the light source 14 is adjusted and the resulting output short circuit current of the first control cell is measured until the percentage difference is less than the targeted maximum percentage current difference.

A second control cell is then placed inside the apparatus 10 and connected to measurement circuitry. The second control cell is designed for monitoring a light intensity in a first wavelength range, which may be from about 620 nm to 750 nm. A third control cell is subsequently placed inside the apparatus 10 and connected to measurement circuitry. The third control cell is designed for monitoring a light intensity in a second wavelength range, which may be from about 440 nm to 490 nm. Output short circuit currents of both the second control cell and the third control cell are then measured. A light intensity ratio equal to the output short circuit current of the second control cell divided by the output short circuit current of the third control cell is then computed. After these steps are repeated on several occasions, a percentage difference between consecutive light intensity ratios is then calculated. If this percentage difference is more than a targeted maximum percentage ratio difference, the light source 14 is replaced and all of these steps are repeated.

A monitoring module 24 is then placed inside the apparatus 10 and connected to measurement circuitry. Subsequently, an output short circuit current, an output open circuit voltage and a quantum efficiency of the monitoring module 24 are measured several times. A percentage difference between the output short circuit current measured on the last occasion and an average of the previously measured output short circuit currents is then computed. Next, a percentage difference between the output open circuit voltage measured on the last occasion and an average of the previously measured output open circuit voltages is calculated. Likewise, a percentage difference between the quantum efficiency measured on the last occasion and an average of the previously measured quantum efficiencies is also computed. If the percentage difference in short circuit currents is less than a targeted maximum percentage current difference, the percentage difference in open circuit voltages is less than a targeted maximum percentage voltage difference, and the percentage difference in quantum efficiencies is less than a targeted maximum percentage efficiency difference, the method ends and the light source 14 has been calibrated. However, if the percentage difference in short circuit currents is more than the targeted maximum percentage current difference, the percentage difference in open circuit voltages is more than the targeted maximum percentage voltage difference, or the percentage difference in quantum efficiencies is more than the targeted maximum percentage efficiency difference, the procedure continues with a reference module 24, as now discussed.

A reference module 24 is placed inside the apparatus 10 and connected to measurement circuitry. An output short circuit current, an output open circuit voltage and a quantum efficiency of the reference module 24 are then measured. Next, a percentage difference between the measured output short circuit current and an externally calibrated short circuit current is calculated. A percentage difference between the measured output open circuit voltage and an externally calibrated open circuit voltage of the reference module is also computed. Likewise, a percentage difference between the measured quantum efficiency and an externally calibrated quantum efficiency of the reference module is calculated. If the percentage difference in short circuit currents is less than a targeted maximum percentage current difference, the percentage difference in open circuit voltages is less than a targeted maximum percentage voltage difference, and the percentage difference in quantum efficiencies is less than a targeted maximum percentage efficiency difference, the procedure ends and the light source 14 has been calibrated. However, if the percentage difference in short circuit currents is more than the targeted maximum percentage current difference, the power supplied to the light source 14 is adjusted. The resulting output short circuit current of the reference module 24 is measured until the percentage difference in short circuit currents is less than the targeted maximum percentage current difference.

Next, the output short circuit current, the output open circuit voltage and the quantum efficiency of the reference module 24 are measured. Percentage differences between the measured output short circuit current and an externally calibrated short circuit current of the reference module, the measured output open circuit voltage and an externally calibrated open circuit voltage of the reference module, and the measured quantum efficiency and an externally calibrated quantum efficiency of the reference module are then calculated. If the percentage difference in open circuit voltages is more than a targeted maximum percentage voltage difference and the percentage difference in quantum efficiencies is more than a targeted maximum percentage efficiency difference, a detailed system check of the apparatus 10 must be undertaken. If the percentage difference in short circuit currents is less than a targeted maximum percentage current difference, the method terminates. Alternatively, if the percentage difference in short circuit currents is more than the targeted maximum percentage current difference, a detailed system check of the apparatus 10 should be performed.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments. The order of description of the above method should not be considered limiting, and methods may use the described operations out of order or with omissions or additions.

It is to be understood that the above description is intended to be illustrative, and not restrictive. Many other embodiments will be apparent to those of ordinary skill in the art upon reviewing the above description. The scope of the invention should, therefore, be determined with reference to the appended claims, along with the full scope of equivalents to which such claims are entitled.

1. A method of calibrating a light source used as a solar simulator in solar cell testing apparatus comprising:
a) using a control cell to measure the intensity of light from the light source at a first wavelength range, the intensity being measured as a function of output short circuit current of the control cell;
b) comparing the measured intensity to a targeted intensity value;
c) optionally adjusting power to the light source until the measured intensity is substantially equal to the targeted intensity value;
d) using a calibrated monitoring module to periodically measure monitoring measured values for monitoring module output short circuit current, monitoring module output open circuit voltage and monitoring module quantum efficiency;
e) repeating step d) and obtaining average values for monitoring module output short circuit current, monitoring module output open circuit voltage and monitoring module quantum efficiency;
f) comparing the measured values obtained in step d) with the average values obtained in step e); and
g) determining if differences in the measured values obtained in step d) and the average values obtained in step e) are within an acceptable limit.

2. The method of calibrating a light source of claim 1, further comprising, in step a), using a control cell to measure the intensity of light from the light source at a second wavelength range, the intensity being measured as a function of output short circuit current of the control cell and calculating a ratio of light intensity at the first and second wavelengths to provide a measured intensity ratio, and in step b) comparing the measured intensity ratio to a targeted intensity ratio value.

3. The method of calibrating a light source of claim 1, wherein when the differences obtained in step g) are greater than an acceptable value, the method further comprising:
h) using a calibrated reference module to obtain reference module measured values for reference module output short circuit current, reference module output open circuit voltage and reference module quantum efficiency;
i) comparing the reference module measured values obtained in step h) to calibrated values for output short circuit current, open circuit voltage and quantum efficiency; and
j) determining if differences in measured values obtained in step h) and calibrated values are within an acceptable limit.

4. The method of calibrating a light source of claim 1, wherein when the differences obtained in step j) are greater than an acceptable value, the method further comprising:
k) adjusting power to the light source until the measured output short circuit current is within the acceptable limit.

5. The method of calibrating a light source of claim 4, further comprising:
l) repeating step h);
m) comparing the reference module measured values obtained in step l) to calibrated values for output short circuit current, open circuit voltage and quantum efficiency; and
n) determining if differences in measured values obtained in step l) and calibrated values are within an acceptable limit.

6. The method of calibrating a light source of claim 5, wherein when the differences obtained in step n) are less than an acceptable value, the method further comprising:
o) using the calibrated reference module to obtain a reference module measured value for reference module output short circuit current; and
p) determining if a difference in measured value obtained in step o) and a calibrated value is within an acceptable limit.

7. The method of calibrating a light source of claim 3, wherein steps a) through c) are performed for each solar cell measurement, steps d) through g) are performed at least once daily, and steps g) through h) are performed on a weekly basis.

8. The method of calibrating a light source of claim 1, wherein an acceptable percentage difference between the measured intensity and the targeted intensity value in b) is about 1%.

9. The method of calibrating a light source of claim 1, wherein an acceptable percentage difference in monitoring module output short circuit current determined in step g) is about 2%, an acceptable percentage difference in monitoring module output open circuit voltage determined in step g) is about 2% and an acceptable percentage difference in monitoring module quantum efficiency determined in step g) is about 4%.

10. The method of calibrating a light source of claim 3, wherein an acceptable percentage difference in monitoring module output short circuit current determined in step j) is about 1%, an acceptable percentage difference in monitoring module output open circuit voltage determined in step j) is about 1% and an acceptable percentage difference in monitoring module quantum efficiency determined in step j) is about 2%.

11. The method of calibrating a light source of claim 1, wherein the targeted maximum percentage voltage difference in n) is about 1% and the targeted maximum percentage efficiency difference in n) is about 2%.

12. The method of calibrating a light source of claim 1, wherein the control cell is a single crystal silicon cell having an appropriate band pass filter approximating tandem-junction spectra responses, has dimensions of about 2 cm×2 cm and is mounted in a hermetic package.

13. The method of calibrating a light source of claim 1, wherein the monitoring module comprises a junction box which is also used to monitor intensity of light from the light source and electrical connections.

14. The method of calibrating a light source of claim 3, wherein the reference module is a filtered crystal silicon module designed to match an output short circuit current, an output open circuit voltage and a quantum efficiency of an amorphous silicon module.

15. The method of calibrating a light source of claim 13, wherein the reference module is a crystal silicon solar cell module with dimensions of about 50 cm×50 cm and having a plurality of cells in series and an appropriate band pass filter.

16. The method of claim 2, wherein the solar cell testing apparatus is configured for measuring tandem junction solar cell modules.

17. The method of calibrating a light source of claim 1, further comprising, in step a), monitoring an intensity of light from the light source by measuring an output short circuit current of the control cell on a daily basis.

18. The method of calibrating a light source of claim 1, further comprising, in step d), measuring an output short circuit current, an output open circuit voltage and a quantum efficiency of the monitoring module on a daily basis.

19. The method of calibrating a light source of claim 3, h) further comprising measuring an output short circuit current, an output open circuit voltage and a quantum efficiency of the reference module on a weekly basis.

20. The method of calibrating a light source of claim 1, wherein the first wavelength range is in the range of about 620 nm to 750 nm.

21. The method of calibrating a light source of claim 2, wherein the second wavelength range is in the range of about 440 nm to 490 nm.

22. The method of calibrating a light source of claim 2, wherein an acceptable percentage difference between the measured intensity and the targeted intensity value in b) is about 1%.

23. The method of calibrating a light source of claim 2, wherein an acceptable percentage difference in intensity ratio measured in b) is about 3%.

24. The method of calibrating a light source of claim 2, wherein an acceptable percentage difference in monitoring module output short circuit current determined in step g) is about 2%, an acceptable percentage difference in monitoring module output open circuit voltage determined in step g) is about 2% and an acceptable percentage difference in monitoring module quantum efficiency determined in step g) is about 4%.

25. The method of calibrating a light source of claim 3, wherein an acceptable percentage difference in reference module output short circuit current determined in step j) is about 1%, an acceptable percentage difference in reference module output open circuit voltage determined in step j) is about 1% and an acceptable percentage difference in reference module quantum efficiency determined in step j) is about 2%.
